(19) United States
(12) Patent Application Publication
(10) Pub. No.: US 2012/0299876 A1
(43) Pub. Date: Nov. 29, 2012

(54) ADAPTABLE PROJECTION ON OCCLUDING OBJECT IN A PROJECTED USER INTERFACE

(75) Inventors: David De Leon, Lund (SE); Johan Thoresson, Goteborg (SE)

(73) Assignee: SONY ERICSSON MOBILE COMMUNICATIONS AB, Lund (SE)

(21) Appl. No.: 13/260,411

(22) PCT Filed: Aug. 18, 2010
(86) PCT No.: PCT/IB10/53730

§ 371 Date: Sep. 26, 2011

(51) Int. Cl. G06F 3/042

(52) U.S. Cl. 345/175

(57) ABSTRACT

A device (100) includes an image generation unit (720) configured to generate an image of a user interface (UI) and a UI projector (105) configured to project the image in a projection area adjacent to the device to generate a projected UI. The device (100) further includes a camera (125) configured to generate an image of the projection area and an image processing unit (700) configured to process the generated image to identify an occluding object in the projection area. The device (100) also includes a UI control unit (710) configured to adapt the projected UI based on identification of an occluding object in the projection area.

### BACKGROUND

Many different types of consumer electronics devices nowadays typically include a touch screen disposed on one surface of the devices. The touch screen acts as an output device that displays image, video and/or graphical information, and acts as an input touch interface device for receiving touch control inputs from a user. A touch screen (or touch panel, or touch panel display) may detect the presence and location of a touch within the area of the display, where the touch may include a touching of the display with a body part (e.g., a finger) or with certain objects (e.g., a stylus). Touch screens typically enable the user to interact directly with what is being displayed, rather than indirectly with a cursor controlled by a mouse or touchpad. Touch screens have become widespread in use with various different types of consumer electronic devices, including, for example, cellular radiotelephones, personal digital assistants (PDAs), and hand-held gaming devices. A factor limiting the usefulness of touch screens is the limited surface area that may actually be used. In particular, touch screens used with hand-held and/or mobile devices have very limited surface areas in which touch input may be received and output data may be displayed.

Virtual keyboards, or projected user interfaces (UIs), are recent innovations in device technology that attempt to increase the size of the UI relative to, for example, the small size of a touch screen. With virtual keyboards, or projected UIs, the device includes a projector that projects an image of the UI on a surface adjacent to the device, enabling a larger output display for use by the user.

### SUMMARY

In one exemplary embodiment, a method may include projecting a user interface (UI) in a projection area adjacent to a device to generate a projected UI, and identifying an occluding object in the projection area of the projected UI. The method may further include adapting the projected UI based on identification of the occluding object in the projection area, where adapting the projected UI comprises altering the projected UI to mask the occluding object or adapting a portion of graphics of the UI projected on or near the occluding object.

Additionally, altering the projected UI to mask the occluding object may include removing, from the user interface, graphics that would be projected onto the occluding object.

Additionally, adapting the projected UI may include projecting graphics associated with the projected UI onto the occluding object.

Additionally, adapting the projected UI may further include projecting information related to use of the projected UI onto the occluding object.

Additionally, projecting information related to use of the projected UI includes projecting information related to use of a tool palette of the projected UI onto the occluding object.

Additionally, the method may further include determining a projection mode associated with the projected UI, where determining a projection mode comprises one or more of: determining a context of use of the projected UI, determining user interaction with the projected UI or the device, or determining one or more gestures of the user in the projection area.

Additionally, the one or more gestures may include at least one of pointing a finger of a hand of the user, making a circular motion with a finger of the hand of the user, wagging a finger of the hand of the user, or clutching the hand of the user.

Additionally, adapting the projected UI may further be based on the determined projection mode associated with the projected UI.

Additionally, the device may include a hand-held electronic device.

In another exemplary embodiment, a device may include an image generation unit configured to generate an image of a user interface (UI), and a UI projector configured to project the image in a projection area adjacent the device to generate a projected UI. The device may further include a camera configured to generate an image of the area, and an image processing unit configured to process the generated image to identify an occluding object in the projection area. The device may also include a UI control unit configured to adapt the projected UI based on identification of an occluding object in the projection area.

Additionally, the UI control unit, when adapting the projected UI, may be configured to alter the projected UI to mask the occluding object.

Additionally, the UI control unit, when adapting the projected UI, may be configured to adapt a portion of graphics of the projected UI on or near the occluding object.

Additionally, when adapting a portion of graphics of the projected UI, the UI control unit may be configured to control the image generation unit and UI projector to project graphics onto the occluding object.

Additionally, when adapting a portion of graphics of the projected UI, the UI control unit may be configured to control the image generation unit and UI projector to project information related to use of the UI onto the occluding object.

Additionally, the occluding object in the projection area may include a hand of a user of the device.

Additionally, the device may include one of a cellular radiotelephone, a satellite navigation device, a smart phone, a Personal Communications System (PCS) terminal, a personal digital assistant (PDA), a gaming device, a media player device, a tablet computer, or a digital camera.

Additionally, the device may include a hand-held electronic device.

Additionally, the control unit may be further configured to: determine a projection mode associated with the projected UI based on a context of use of the projected UI, user interaction with the projected UI or the device, or one or more gestures of the user in the projection area.

Additionally, the one or more gestures may include at least one of pointing a finger of a hand of the user, making a circular motion with a finger of the hand of the user, wagging a finger of the hand of the user, or clutching the hand of the user.

Additionally, the UI control unit may be configured to adapt the projected UI further based on the determined projection mode associated with the projected UI.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram that illustrates an overview of the adaptable projection of a user interface on an occluding object;

FIGS. 2-5 depict examples of the adaptable projection of a user interface on an occluding object;

FIG. 6 is a diagram of an exemplary external configuration of the device of FIG. 1;

FIG. 7 is a diagram of exemplary components of the device of FIG. 1; and

FIGS. 8-10 are flow diagrams illustrating an exemplary process for adapting a projected user interface on an occluding object based on a determined projection mode of the projected user interface.

### DETAILED DESCRIPTION

The following detailed description refers to the accompanying drawings. The same reference numbers in different drawings may identify the same or similar elements. Also, the following detailed description does not limit the invention.

### Overview

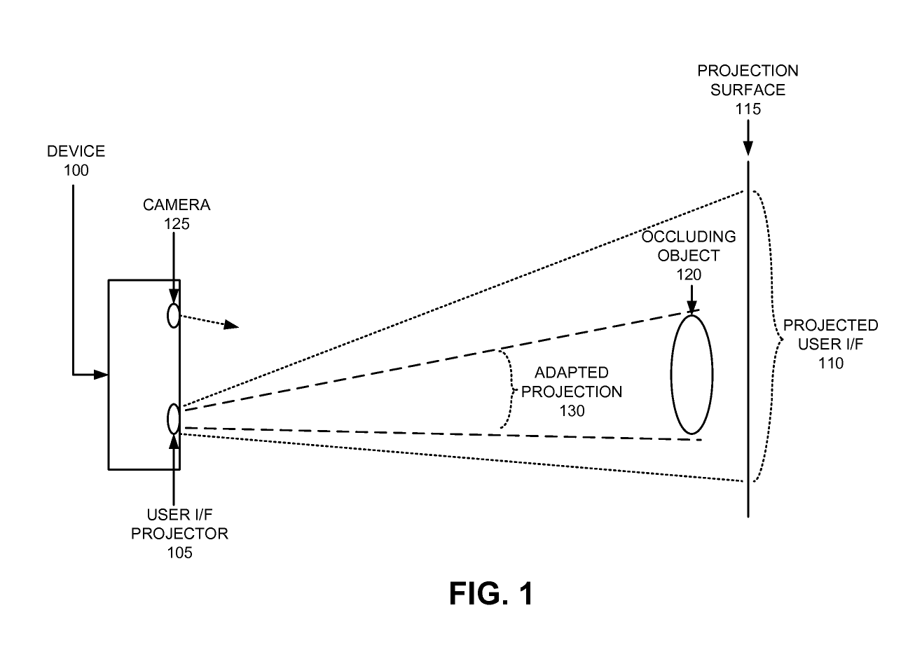

FIG. 1 illustrates an overview of the adaptable projection of a projected user interface on an occluding object. As shown in FIG. 1, a device 100 may include a user interface (I/F) projector 105 that may be used to project an image or images of a projected user interface (UI) 110 onto a projection surface 115 that is adjacent to device 100. The projected image of the projected UI 110 may include various types of menus, icons, etc. associated with applications and/or functions that may be accessed through projected UI 110. Projection surface 115 may include any type of surface adjacent to device 100, such as, for example, a table or a wall. Device 100 may include any type of electronic device that employs a user interface for user input and output. For example, device 100 may include a cellular radiotelephone; a satellite navigation device; a smart phone; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; a gaming device; a media player device; a tablet computer; or a digital camera. In some exemplary embodiments, device 100 may include a hand-held electronic device.

As further shown in FIG. 1, an occluding object 120 may be placed within the projected image of projected UI 110. Occluding object 120 may include any type of object that may be placed within the projected image of projected UI 110. In one example, occluding object 120 may include the hand of the user of device 100. A camera 125 of device 100, and an associated image processing unit (not shown), may determine that occluding object 120 is located within the projection area of projected UI 110 and may provide signals to a UI control unit (not shown), based on a projection mode of projected UI 110, for adapting a portion of the projected image of projected UI 110 to generate an adapted projection 130 on or near occluding object 120. The projection mode of projected UI 110 may be selected based on overt user interface interaction by a user of device 100, by a context of use of projected UI 110 or device 100, and/or by one or more gestures by a user of device 100.

When interacting with UI 110 projected on projection surface 115, a user's hand will occasionally occlude the projection. Sometimes this may be acceptable, such as when a hand accidentally passes through the projected area, but at other times it can be distracting. For example, if a user is interacting with projected UI 110, the UI image on the occluding hand can make it difficult to see the position, shape and gestures of the hand and how it relates to the underlying UI. Exemplary embodiments described herein enable the context of use of device 100 or UI 110, a user's hand gestures, and/or overt user UI interaction to trigger an appropriate adaptation of a part of a UI image projected on an occluding object that is placed within the projection area of projected UI 110.

Device 100 is depicted in FIG. 1 as including a single projector 105. However, in other implementations, device 100 may include two or more projectors, with one or more of these projectors being dedicated for projecting on occluding objects. These additional projectors could be placed on device 100 such that the “bottom” user interface projection (i.e., the user interface projection under the occluding object) has an unbroken projection even though the occluding object may be occluding the “sight lines” for most individuals viewing the projected user interface. An individual user to the side of the projected user interface may be able to see both the projection on the occluding object as well as beneath/behind the occluding object.

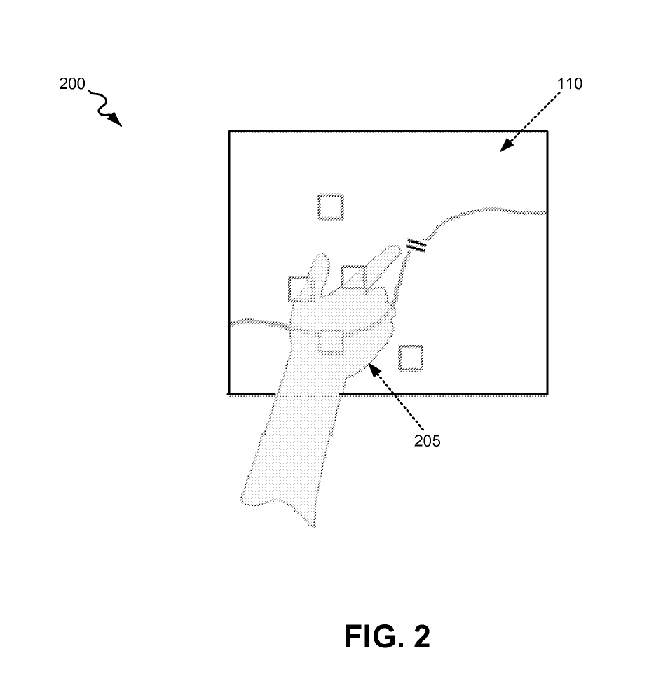

FIGS. 2-5 depict a number of examples of the adaptable projection of a user interface on an occluding object. In a first example 200 shown in FIG. 2, the adaptable projection of UI may include projecting the UI normally onto the occluding object. For example, as shown in FIG. 2, a hand 205 (or other object) may pass through the projection area of projection UI 110 and may, therefore, occlude the projection. In this situation, allowing projected UI 110 to be projected onto the occluding hand (or other object) may minimize the distraction. For example, a coffee cup (not shown) accidentally left in the projection area of projected UI 110 can be projected upon, as well as the hand (i.e., hand 205 shown in FIG. 2) that passes through the projection area to pick up the cup can be projected upon. However, when projecting the UI normally onto the occluding object, the projection onto the occluding object may be adapted to compensate for distortions due to the hand being at a different focus length from the background projected user I/F.

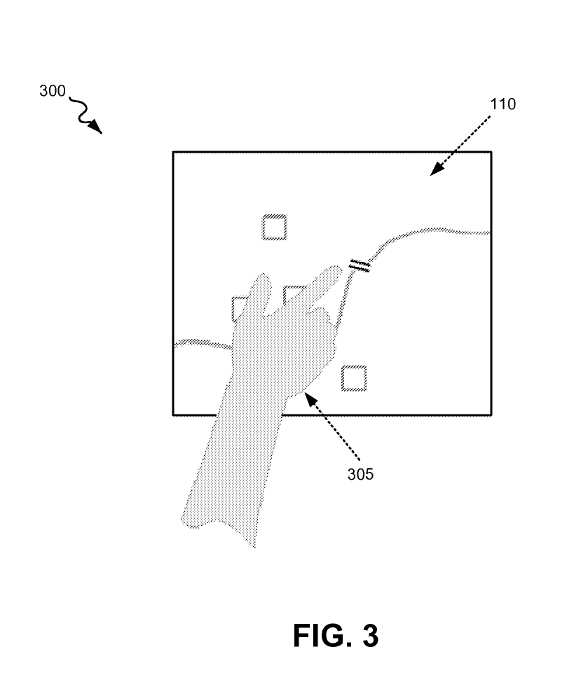

In a second example 300 shown in FIG. 3, the portion of projected UI 110 projected on an occluding object may be masked. The portion of projected UI 110 is masked when the portion of projected UI 110 in the vicinity of the occluding object is masked, blocked out, or otherwise removed from the UI image. Masking of the UI in the region of the occluding object may be an appropriate system response in certain circumstances such as, as shown in the example of FIG. 3, when a hand 305 is used to point at some portion of UI 110, and a portion of UI 110 in the shape of hand 305 is removed (i.e., not projected on hand 305) such that the pointing gesture, and the target of the pointing gesture, stands out more clearly against projected UI 110.

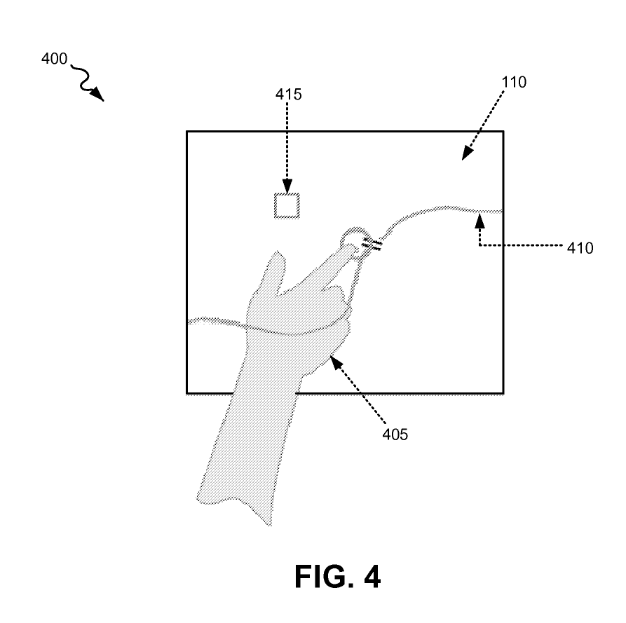

In another example 400 shown in FIG. 4, a portion of the UI graphics projected on or near the occluding object (e.g., hand 405) can be adapted. As shown in example 400, hand 405 is tracing a route along a river 410, left to right, on a projected map. While hand 405 traces river 410 from left to right on the projected map, the line of river 410 may be projected on hand 405, and other distracting objects on the map may be temporarily removed, to enable the user to more easily follow the route of river 410 with the user's finger. Additionally, a portion of the graphics projected near hand 405 may be adapted. As shown in FIG. 4, a circle 415 is displayed on projected UI 110 “beneath” a finger of hand 405 to emphasize where hand 405 is pointing.

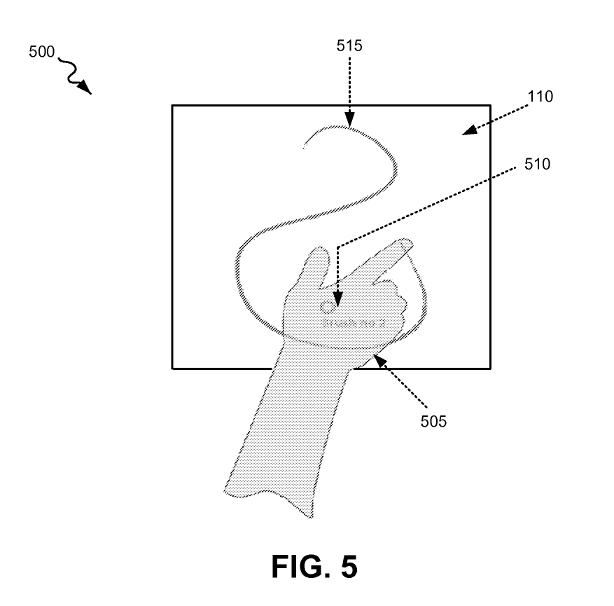

FIG. 5 depicts a further example 500 of the adaptation of a portion of the UI graphics projected on or near an occluding object (e.g., hand 505). As shown in FIG. 5, the back of hand 505 can be used as a surface upon which to project additional information. For example, if the user has selected a tool from a tool palette, an icon 510 can be projected on hand 505 to indicate the current tool selection, as well as additional information relevant to the tool. The additional relevant information may include, for example, current settings for the tool or help instructions for the tool. Though not shown in FIG. 5, the tool palette itself may be projected onto the back of the user's hand, enabling the user to select and change tools (or select commands) from their own hand. FIG. 5 further depicts a finger of hand 505 being used to draw a line 515 on projected UI 110. In such a case, the drawing may be projected onto hand 505 to enable the user to see the entire drawn line so that it is possible to draw with better precision. By projecting the drawing onto hand 505, the exact portion of the finger that is generating the drawn line is apparent, and it is also easier to complete the drawing of shapes when the entirety of the shape can be seen (i.e., projected on hand 505).

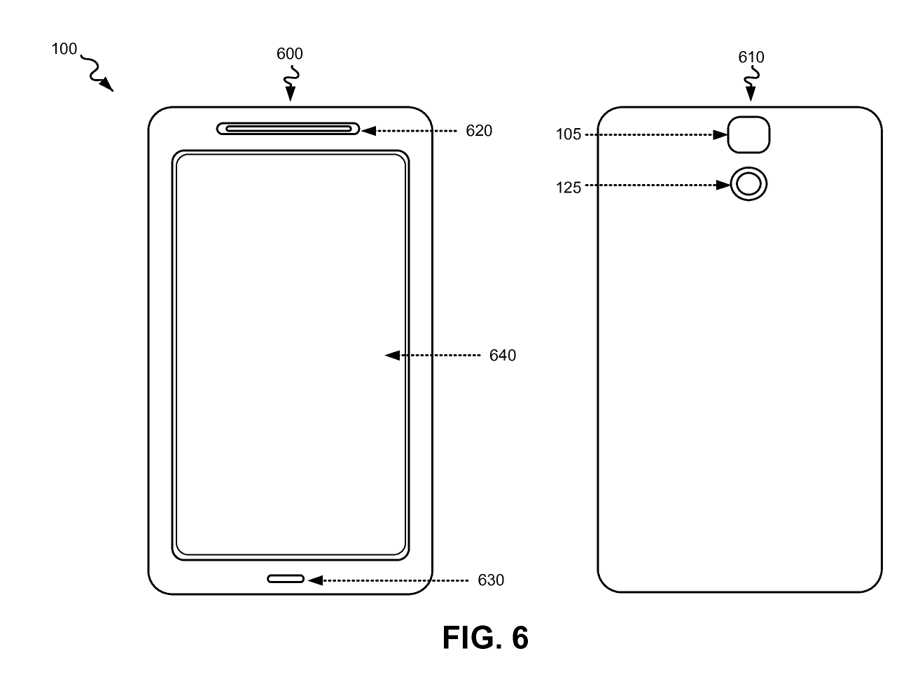

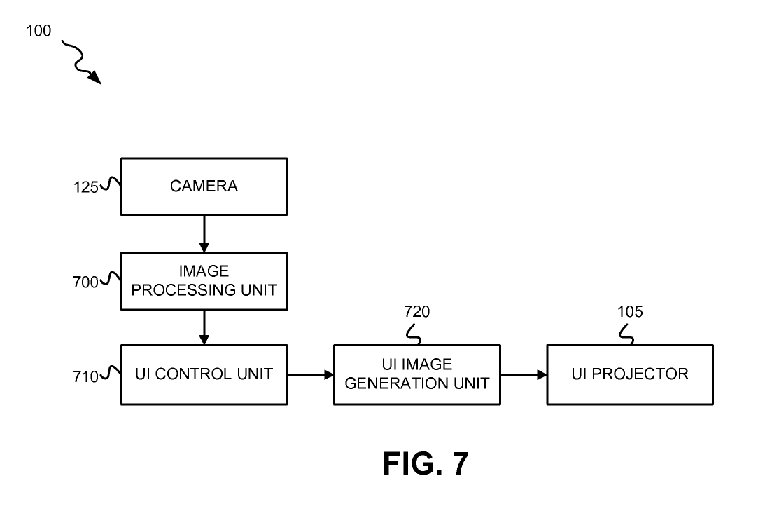

FIG. 6 is a diagram of an external configuration of device 100. In this exemplary implementation, device 100 includes a cellular radiotelephone. FIG. 6 depicts a front 600 and a rear 610 of device 100. As shown in FIG. 6, front 600 of device 100 may include a speaker 620, a microphone 630 and a touch panel 640. As further shown in FIG. 6, rear 610 of device 100 may include a UI projector 105 and a camera 125. UI projector 105 projects UI 110 onto projection surface 115, and is described further below with respect to FIG. 7. Camera 125, as described above with respect to FIG. 1, captures digital images of UI 110, and any occluding objects placed in the projection area, and provides those digital images to an image processing unit (not shown) described below with respect to FIG. 7.

Touch panel 640 may be integrated with, and/or overlaid on, a display to form a touch screen or a panel-enabled display that may function as a user input interface (i.e., a UI that can be used when the projected UI is turned off). For example, in one implementation, touch panel 640 may include a near field-sensitive (e.g., capacitive), acoustically-sensitive (e.g., surface acoustic wave), photo-sensitive (e.g., infrared), and/or any other type of touch panel that allows a display to be used as an input device. In another implementation, touch panel 640 may include multiple touch-sensitive technologies. Generally, touch panel 640 may include any kind of technology that provides the ability to identify the occurrence of a touch upon touch panel 640. The display associated with touch panel 640 may include a device that can display signals generated by device 100 as text or images on a screen (e.g., a liquid crystal display (LCD), cathode ray tube (CRT) display, organic light-emitting diode (OLED) display, surface-conduction electro-emitter display (SED), plasma display, field emission display (FED), bistable display, etc.). In certain implementations, the display may provide a high-resolution, active-matrix presentation suitable for the wide variety of applications and features associated with typical devices. The display may provide visual information to the user and serve—in conjunction with touch panel 640—as a user interface to detect user input when projected UI 110 is turned off (or may be used in conjunction with projected UI 110). In some embodiments, device 100 may only include a projected UI 110 for a user input interface, and may not include touch panel 640.

FIG. 7 is a diagram of exemplary components of device 100. As shown in FIG. 7, device 100 may include camera 125, an image processing unit 700, a UI control unit 710, a UI image generation unit 720, and a UI projector 105.

Camera 125 may include a digital camera for capturing digital images of the projection area of projected UI 110. Image processing unit 700 may receive digital images from camera 125 and may apply image processing techniques to, for example, identify an occluding object in the projection area of projected UI 110. Image processing unit 700 may also apply image processing techniques to digital images from camera 125 to identify one or more gestures when the occluding object is a hand of a user of device 100. UI control unit 710 may receive data from image processing unit 700 and may control the generation of projected UI 110 by UI image generation unit 720 based on the data from image processing unit 700. UI control unit 710 may control the adaptation of portions of the graphics of projected UI 110 based on a selected projection mode. UI image generation unit 720 may generate an image of the UI to be projected by UI projector 105. The generated image may include all icons, etc. that are to be displayed on projected UI 110. UI projector 105 may include optical mechanisms for projecting the UI image(s) generated by UI image generation unit 720 onto projection surface 115 to produce projected UI 110 with which the user of device 100 may interact.

### Exemplary Process

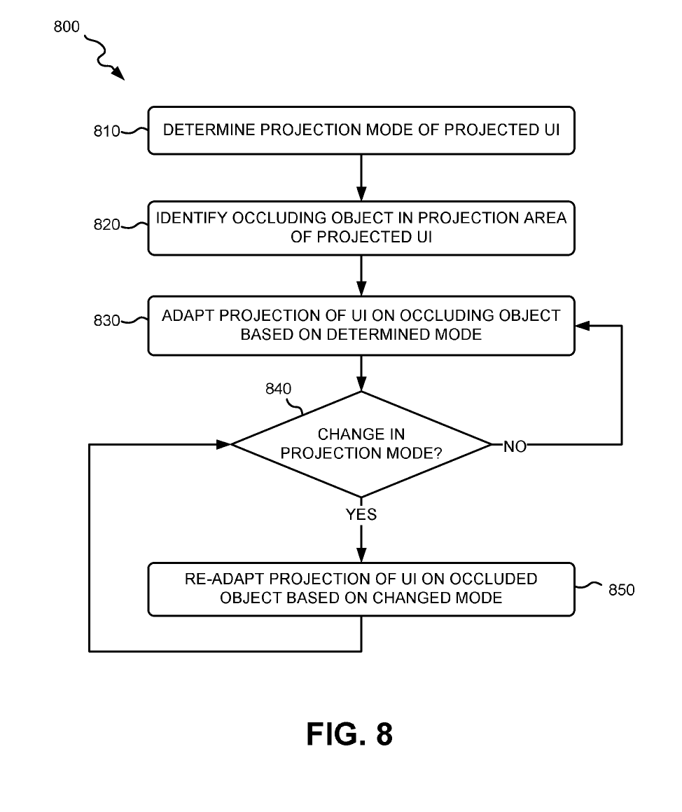

FIGS. 8-10 are flow diagrams illustrating an exemplary process for adapting a projected user interface on an occluding object based on a determined projection mode of projected user interface 110. The exemplary process of FIGS. 8-10 may be performed by various components of device 100.

The exemplary process may include determining a projection mode of projected UI 110 (block 810). The projection mode of projected UI 110 may be determined based on various factors, including, for example, a determined context of use of the projected UI, one or more gestures of the user in the projected UI, and/or explicit user interaction with the UI or with device 100. The projection mode of projected UI 110 may be determined by UI control unit 710.

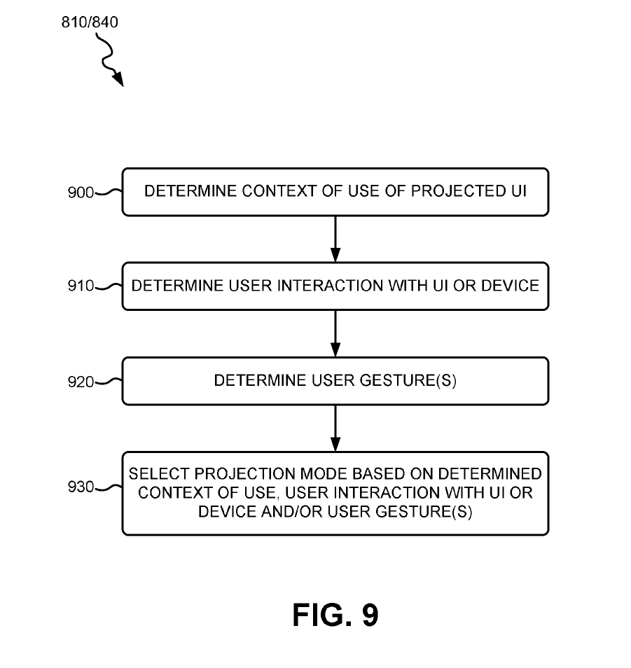

FIG. 9 depicts further details of block 810. As shown in FIG. 9, a context of use of projected UI 110 may be determined (block 900). For example, the context of use may include the use of projected UI 110 in the context of the execution of one or more specific applications. The context of use may also include, for example, a location at which a user gesture is made (block 920 below). User interaction with the UI or device 100 may be determined (block 910). The user of device 100 may manually select certain functions or modes via projected UI 110, or via a UI on touch screen 640. For example, mode selection may be achieved through multiple different types of input. As an example, the user may point and say the word “there,” and this combination of image recognition input and voice recognition input may trigger a UI projection mode that is different from the mode triggered by merely pointing. As an additional example, UI 110 or device 100 may include a mode selector (e.g., a mode selector palette) that enables the user to select the projection mode.

User gesture(s) may be determined (block 920). The user of device 100 may perform certain hand gestures in the projection area of projected UI 110. Such gestures may include, for example, pointing with a finger of the user's hand, making a circular motion with a finger of the user's hand, wagging a finger of the user's hand, clutching the user's hand, etc. Other types of user gestures, however, may be used. The projection mode may be selected based on the context of use (i.e., determined in block 900), the user interaction with the UI or with device 100 (i.e., determined in block 910) and/or user gestures (i.e., determined in block 920) (block 930). The projected mode selected may include, for example, a “project normally” mode in which the UI is projected onto the occluding object, a “mask occluding object” mode in which the projected UI in the vicinity of the occluding object is masked, and/or an “adapt UI graphics” mode in which graphics on or near the occluding object are altered.

Returning to FIG. 8, an occluding object in the projection area of projected UI 110 may be identified (block 820). Camera 125 may supply one or more digital images to image processing unit 700, and image processing unit 700 may identify the existence of one or more occluding objects in the projection area of projected UI 110. Identification of the occluding object(s) may include identifying the physical dimensions of the occluding object (i.e., the shape) within projected UI 110. Image processing unit 700 may supply data identifying the occluding object to UI control unit 710.

The projection of projected UI 110 on the occluding object may be adapted based on the mode determined in block 810 (block 830). UI control unit 710 may control the adaptation of the projection of projected UI 110.

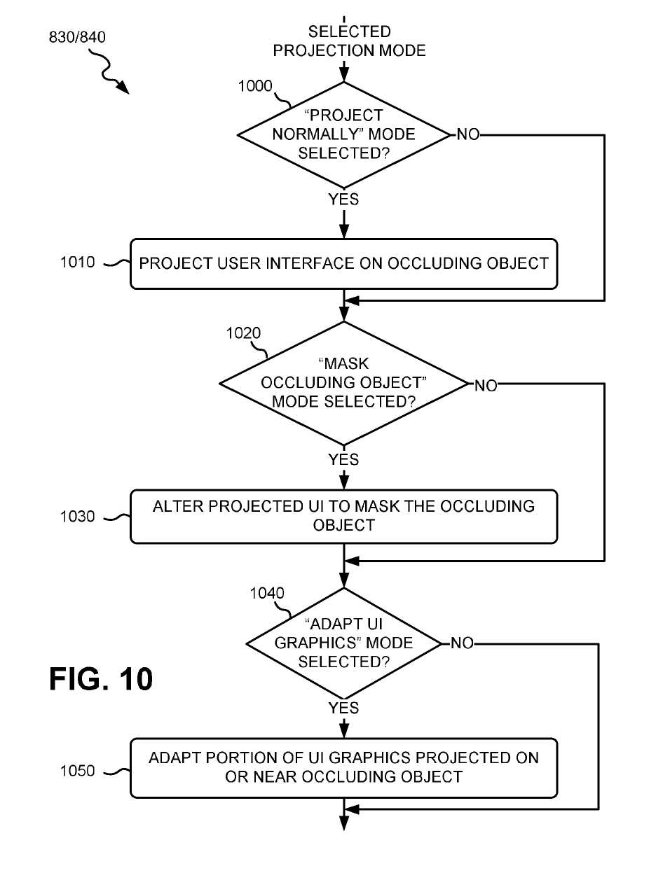

FIG. 10 depicts further details of the adaptation of the projection of projected UI 110 of block 830. As depicted in FIG. 10, it may be determined if a “project normally” mode has been selected in block 930 (block 1000). If so (YES—block 1000), then the UI may be projected normally onto the occluding object (block 1010). In the “project normally” mode, the UI graphics are not altered and no masking of the UI in the vicinity of the occluding object occurs. If the “project normally” mode has not been selected (NO—block 1000), then it may be determined if a “mask occluding object” mode has been selected (block 1020). If so (YES—block 1020), then projected UI 110 may be altered to mask the occluding object (block 1030). Image processing unit 700 may identify the shape of the occluding object within projected UI 110, and UI control unit 710 may, based on data received from image processing unit 700, then control UI image generation unit 720 such that UI image generation unit 720 generates an image of the UI where the UI is masked in the shape and location of the occluding object. If the “mask occluding object” mode has not been selected (NO—block 1020), then it may be determined if the “adapt UI graphics” mode has been selected (block 1040). If so (YES—block 1040), then a portion of UI graphics projected on or near the occluding object may be adapted (block 1050). Adaptation of the portion of the UI graphics projected on or near the occluding object may include the examples of FIGS. 4 and 5, or other types of graphics adaptation. After block 1050, the exemplary process may continue at block 840 (FIG. 8). If the “adapt UI graphics” mode has not been selected (NO—block 1040), then the exemplary process may continue at block 840.

Returning to FIG. 8, It may be determined whether there has been a change in the projection mode of projected UI 110 (block 840). The exemplary blocks of FIG. 9 may be repeated to identify any changes in the context of use, user interaction with the UI or device 100, or user gestures so as to select a new projection mode of projected UI 110. The projection of projected UI 110 on the occluded object may be re-adapted based on the changed projection mode (block 850). The details of block 830, described above with respect to the blocks of FIG. 10, may be similarly repeated in block 850.

### CONCLUSION

Implementations described herein provide mechanisms for adapting portions of a projected UI on or near occluding objects in the projection area of the projected UI. The portions of the projected UI on or near the occluding objects may be adapted to suit the task or tasks being performed by the user on the projected UI.

The foregoing description of the embodiments described herein provides illustration and description, but is not intended to be exhaustive or to limit the invention to the precise form disclosed. Modifications and variations are possible in light of the above teachings or may be acquired from practice of the invention. For example, while a series of blocks has been described with respect to FIGS. 8-10, the order of the blocks may be varied in other implementations. Moreover, non-dependent blocks may be performed in parallel. Embodiments have been described herein with respect to a single user interacting with a projected user interface. However, in other implementations, multiple users may interact with the projected user interface. For example, if two users are interacting with the projected user interface, the hands of each user may be identified (using image recognition techniques) such that interactions between the users may be permitted. As an example, if one user has a palette projected on their hand, then this user could transfer the palette to another user by simply touching the other user's hand, or by a specific “hand-over” gesture.

Certain features described herein may be implemented as “logic” or as a “unit” that performs one or more functions. This logic or unit may include hardware, such as one or more processors, microprocessors, application specific integrated circuits, or field programmable gate arrays, software, or a combination of hardware and software.

The term “comprises” or “comprising” as used herein, including the claims, specifies the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

What is claimed is:

1. A method, comprising:
projecting a user interface (UI) in a projection area adjacent to a device to generate a projected UI;
identifying an occluding object in the projection area of the projected UI; and
adapting the projected UI based on identification of the occluding object in the projection area, where adapting the projected UI comprises altering the projected UI to mask the occluding object or adapting a portion of graphics of the UI projected on or near the occluding object.

2. The method of claim 1, wherein altering the projected UI to mask the occluding object comprises removing, from the user interface, graphics that would be projected onto the occluding object.

3. The method of claim 1, wherein adapting the projected UI comprises:
projecting graphics associated with the projected UI onto the occluding object.

4. The method of claim 3, wherein adapting the projected UI further comprises:
projecting information related to use of the projected UI onto the occluding object.

5. The method of claim 4, wherein projecting information related to use of the projected UI comprises:
projecting information related to use of a tool palette of the projected UI onto the occluding object.

6. The method of claim 1, further comprising:
determining a projection mode associated with the projected UI, where determining a projection mode comprises one or more of:
determining a context of use of the projected UI,
determining user interaction with the projected UI or the device, or
determining one or more gestures of the user in the projection area.

7. The method of claim 6, wherein the one or more gestures comprise at least one of pointing a finger of a hand of the user, making a circular motion with a finger of the hand of the user, wagging a finger of the hand of the user, or clutching the hand of the user.

8. The method of claim 6, where adapting the projected UI is further based on the determined projection mode associated with the projected UI.

9. The method of claim 1, wherein the device comprises a hand-held electronic device.

10. A device, comprising:
an image generation unit configured to generate an image of a user interface (UI);
a UI projector configured to project the image in a projection area adjacent to the device to generate a projected UI;
a camera configured to generate an image of the area;
an image processing unit configured to process the generated image to identify an occluding object in the projection area; and
a UI control unit configured to adapt the projected UI based on identification of an occluding object in the projection area.

11. The device of claim 10, where the UI control unit, when adapting the projected UI, is configured to alter the projected UI to mask the occluding object.

12. The device of claim 10, where the UI control unit, when adapting the projected UI, is configured to adapt a portion of graphics of the projected UI on or near the occluding object.

13. The device of claim 12, wherein, when adapting a portion of graphics of the projected UI, the UI control unit is configured to control the image generation unit and UI projector to project graphics onto the occluding object.

14. The device of claim 12, wherein, when adapting a portion of graphics of the projected UI, the UI control unit is configured to control the image generation unit and UI projector to project information related to use of the UI onto the occluding object.

15. The device of claim 10, wherein the occluding object in the projection area comprises a hand of a user of the device.

16. The device of claim 10, wherein the device comprises one of a cellular radiotelephone, a satellite navigation device, a smart phone, a Personal Communications System (PCS) terminal, a personal digital assistant (PDA), a gaming device, a media player device, a tablet computer, or a digital camera.

17. The device of claim 10, wherein the device is a hand-held electronic device.

18. The device of claim 10, wherein the control unit is further configured to:
determine a projection mode associated with the projected UI based on a context of use of the projected UI, user interaction with the projected UI or the device, or one or more gestures of the user in the projection area.

19. The device of claim 18, wherein the one or more gestures comprise at least one of pointing a finger of a hand of the user, making a circular motion with a finger of the hand of the user, wagging a finger of the hand of the user, or clutching the hand of the user.

20. The device of claim 18, wherein the UI control unit is configured to adapt the projected UI further based on the determined projection mode associated with the projected UI.
